(19) United States
(12) Patent Application Publication
(10) Pub. No.: US 2018/0003792 A1
(43) Pub. Date: Jan. 4, 2018

(54) MULTI-OPERATIONAL ORIENTATION SYSTEMS FOR AUTONOMOUS VEHICLES AND SMART INFRASTRUCTURE

(71) Applicants: Thomas MCCAFFERTY, New Albany, OH (US); Smart Road Technology, LLC, New Albany, OH (US)

(72) Inventor: Thomas McCafferty, New Albany, OH (US)

(21) Appl. No.: 15/546,704

(22) PCT Filed: Jan. 22, 2016
(86) PCT No.: PCT/US16/14532

§ 371 Date: Jul. 27, 2017

Related U.S. Application Data
(60) Provisional application No. 62/217,946, filed on Sep. 13, 2015.
(60) Provisional application No. 62/108,518, filed on Jan. 27, 2015.

(51) Int. Cl. G01S 1/02; G05D 1/10

(52) U.S. Cl. CPC G01S 1/02; G05D 1/101

(57) ABSTRACT

Presently disclosed is a system, apparatus, and method for navigating and orienting roadway vehicles by use of a network of embedded navigation beacons within a roadway. A plurality of primary navigation beacons are embedded into a roadway surface with sensors, and communicate with a car and a smaller subset of secondary beacons with connection to the internet. Further disclosed is a landing pad for a drone delivery system, the landing pad acting as a navigational beacon and safe landing location indicator for the aerial drone.

### CROSS-REFERENCE TO RELATED APPLICATIONS

The present application is a U.S. National Stage entry under 35 U.S.C. §371 of International Application No. PCT/US16/14532, filed on Jan. 22, 2016, which in turns claims priority to U.S. provisional patent application Ser. No. 62/217,946 filed on Sep. 13, 2015, and U.S. provisional patent application Ser. No. 62/108,518 filed on Jan. 27, 2015, each of which are incorporated herein by reference in their entirety.

### BACKGROUND AND SUMMARY

This application relates generally to the field of orientation systems, particularly for the navigation of motor vehicles and the navigation of aerial drones.

Autonomous vehicles currently utilize combinations of satellite-based GPS signals, radar, and LIDAR, among other technologies to navigate. These vehicles include automobiles, watercrafts, aerial drones, etc. Autonomous vehicle technology provides the opportunity for safer and more convenient transportation and navigation methods.

A simplified summary is provided herein to help enable a basic or general understanding of various aspects of the exemplary, non-limiting embodiments that follow in the more detailed description and the accompanying drawings. This summary is not intended, however, as an extensive or exhaustive overview. Instead, the sole purpose of the summary is to present some concepts related to some exemplary, non-limiting embodiments in a simplified form as a prelude to the more detailed description of the various embodiments that follow.

In various non-limiting embodiments, the presently disclosed navigation system functions by providing road reflectors in the roadway, each reflector containing wireless communication equipment capable of communicating with cars which are using the road. In this manner, each road reflector acts as a navigational beacon. By receiving the signals from each of the beacons via wireless communication, the car can calculate, or triangulate, its precise location.

Provided herein, in one embodiment, is a navigation pod comprising an upper portion, the upper portion having a surface portion a surface portion and a chamber portion, the chamber portion comprising at least one short-range wireless transceiver and a memory, and the surface portion adapted to seal the chamber portion; a lower portion comprising a receptacle, the receptacle adapted to be embedded in a surface, and the receptacle comprising a cavity capable of receiving and connecting to the upper portion; wherein the memory comprises geo-location data of the navigation pod, and wherein the at least one short-range wireless transceiver is adapted to communicate with at least one other navigation pod and is capable of transmitting the geo-location data to an external receiver capable of receiving the geo-location data. In one example, the navigation pod may further include a reflector disposed on the surface portion and the receptacle of the lower portion may be adapted to be embedded in a road surface.

In one embodiment, the navigation pod is a primary navigation pod and the at least one other navigation pod is a secondary navigation pod configured to communicate with an external server. In one example, the primary navigation pod is one primary navigation pod of a plurality of primary navigation pods, and the at least one short-range wireless transceiver is further adapted to transmit the geo-location data to the plurality of primary navigation pods and to receive additional geo-location data from the plurality of primary navigation pods.

In another embodiment, the navigation pod is a secondary navigation pod and the at least one other navigation pod is a primary navigation pod, the secondary navigation pod further comprising a long-range wireless transceiver adapted to communicate with an external server. In one example, the secondary navigation pod is further configured to receive data from and send information to the internet. In another example, the secondary navigation pod is further configured to receive data from and send information to a cloud computing network. In yet another example, the secondary navigation pod is one secondary navigation pod of a plurality of secondary navigation pods, the one secondary navigation pod being configured to communicate with at least one other secondary navigation pod of the plurality of secondary navigation pods. In a further example, the primary navigation pod is one primary navigation pod of a plurality of primary navigation pods, the secondary navigation pod being configured to communicate with the plurality of primary navigation pods.

Also provided herein is a navigational system comprising a plurality of primary navigation pods and at least one secondary navigation pod, the plurality of primary navigation pods and at least one secondary navigation pod comprising at least one short-range wireless transceiver and a memory comprising geo-location data, wherein one primary navigation pod of the plurality of navigation pods is adapted to communicate the geolocation data with at least one other primary navigation pod and the at least one secondary navigation pod via the at least one short-range wireless transceiver, and is capable of transmitting the geo-location data to an external receiver capable of receiving the geo-location data, and wherein the at least one secondary navigation pod is adapted to communicate with the plurality of primary navigation pods and further comprises at least one long-range wireless transceiver configured to communicate with an external server. In one example, the external receiver may be coupled to a roadway vehicle. In another example, the external receiver may be coupled to an aerial vehicle.

In one example embodiment of the navigational system, the memory may also include a position dataset corresponding to a position of each of the plurality of primary navigation pods or the at least one secondary navigation pod. In one example, either one primary navigation pod of the plurality of primary navigation pods or the at least one secondary navigation pod is capable of sending the position data set to the external receiver.

In another embodiment, the plurality of primary navigation pods and the at least one secondary navigation pod are embedded within a roadway at selected increments. In one instance the selected increments are located in a center line of the roadway.

In a further embodiment, a ratio between the plurality of primary navigation pods and the plurality of secondary navigation pods is greater than 1.

In another embodiment, one of the plurality of primary navigation pods or the at least one secondary navigation pods comprises a power source coupled with at least the short-range wireless transceiver, the power source comprising a solar panel disposed on an outer surface of the navigation pod.

In yet another embodiment, the navigational system may further comprise a tertiary navigational sensor in communication with a railway system, the tertiary navigational sensor communicating to the plurality of primary navigation pods and the at least one secondary navigation pod a status of the railway system.

In another embodiment, the primary navigation pods and secondary navigation pods are each shielded from interference and Gamma ray bursts or other radiation interference. In a further embodiment, where the primary navigation pods and secondary navigation pods broadcast their respective latitude, longitude, and altitude coordinates. In yet another embodiment, the primary navigation pods and secondary navigation pods transmit their respective coordinates to a cloud network without requiring line-of-sight with the sky.

Further provided herein is a navigational system comprising A roadway vehicle including a heading, a position, and a velocity, the roadway vehicle having a navigation computer connected to a wireless transceiver; a plurality of navigational beacons embedded within a roadway, each navigational beacon comprising a roadway reflector, a power source, a computer processing unit, and a wireless transceiver emitting the at least one packet of position information; wherein the navigation computer is capable of receiving at least one packet of position information and at least one packet of traffic information from at least some of the plurality of navigation beacons embedded within a roadway; and where the navigation computer sends the heading, the position, and the velocity of the roadway vehicle to the plurality of navigational beacons. In one exemplary embodiment, each navigational beacon of the plurality of navigational beacons is either a primary navigational beacon or a secondary navigational beacon, each secondary navigational beacon is adapted to send and receive information to a central server, and each primary navigational beacon is adapted to communicate with the plurality of secondary navigational beacons.

In one example, the navigational computer receives the at least one packet of position information from each navigational beacon in close proximity to the roadway vehicle, and upon receiving a sufficient number of the at least one packet of position information, the navigational computer triangulates the position of the roadway vehicle. In another example, the navigational computer compares the at least one packet of position information with a GPS signal to calculate the position of the roadway vehicle.

In another embodiment, the navigational computer uses the at least one packet of position information and the at least one packet of traffic information to control the roadway vehicle.

In another embodiment, the power source is a wired connection into an electrical grid.

In one example embodiment, each navigational beacon is adapted to be removable from the roadway.

In another example embodiment, the navigational system includes a tertiary navigational sensor in communication with a railway system.

In yet another embodiment, the plurality of navigational beacons sends at least one packet of roadway condition information to the central server.

In another embodiment, the ratio of primary navigation beacons to secondary navigation beacons is greater than 2.

Also provided herein is a method for communicating alerts across a distributed network comprising: continuously scanning for a trigger event; alerting a secondary navigation beacon once a trigger event occurs; receiving information regarding the trigger event at the secondary navigation beacon from at least one primary navigation beacon; relaying the information received at the secondary navigation beacon to the internet for analysis by a computing cloud or server; communicating reactionary or status information to the secondary navigation beacon from the computing cloud or server; distributing the reactionary or status information to the primary navigation beacons from the secondary navigation beacons; and distributing the reactionary or status information to roadway vehicles from the primary navigation beacons.

A subset of the road reflectors may contain additional, longer range wireless communication equipment. These secondary navigation beacons are capable of communication with not only roadway vehicles but also the internet and any primary navigation beacons located in proximity to the secondary navigation beacons. Among other benefits, this enables significant cost savings by reducing the need for long range wireless equipment for every navigational beacon.

Further disclosed is an aerial navigational system comprising navigational beacons located in a household or other building. By placing a beacon at a home or building, a drone can hone in on that beacon and execute a delivery of a package. These Personal Landing Pads utilize the wireless, Wi-Fi, or other protocols to get the packages delivered to an accurate location and confirm delivery to company and customer.

In accordance with the present innovations, there is provided a navigational system comprising a plurality of primary navigation pods and a plurality of secondary navigation pods. Each primary navigation pod and each secondary navigation pod comprises a road surface reflector, a power source, a computer processing unit, a memory storage bank, an outer shell, a receptacle, and at least one short-range wireless transceiver. The computer processing unit, the memory storage bank, and at least one short-range wireless transceiver are located within the outer shell. The outer shell is removably nested with the receptacle. Each primary navigation pod is configured to communicate with at least one secondary navigation pod. Each secondary navigation pod further comprises at least one long-range wireless transceiver configured to communicate with a central server. The navigational system further comprises a receiver in wireless communication with at least one of the plurality of primary navigation pods and at least one of the plurality of secondary navigation pods.

### BRIEF DESCRIPTION OF THE DRAWINGS

Reference is made to the accompanying drawings in which particular embodiments of the invention are illustrated as described in more detail in the description below, in which:

FIG. 1 illustrates a top view of an embodiment of a navigation pod;

FIG. 2 illustrates an exploded side view of an embodiment of a navigation pod;

FIG. 3 illustrates an embodiment of a primary navigation pod including a diagram of internal components and protocols;

FIG. 4 illustrates an embodiment of a secondary navigation pod including a diagram of internal components and protocols;

FIG. 5 illustrates an embodiment of the navigation system comprising a plurality of navigation pods on a multi-lane highway;

FIG. 6 illustrates an implementation of a mobile application;

FIG. 7 illustrates the implementation of the navigational system according to the invention for a drawbridge scenario;

FIG. 8 illustrates the function of the navigational system according to the invention in an example for use at a railroad crossing;

FIG. 9 is an organization chart that describes the hierarchy of the navigation pod and cloud network system;

FIG. 10 is a flow chart describing the road monitor and alert system for various events according to the invention;

FIG. 11 is a flow chart describing the distribution of alerts and information by navigation pods and the cloud network system according to the invention;

FIG. 12 illustrates an embodiment of a personal landing pad (PLP) guiding an embodiment of a delivery drone to the proper delivery location;

FIG. 13 illustrates an embodiment of a PLP including a diagram of internal components and protocols;

FIG. 14 illustrates multiple location possibilities PLP locations at a residential location with multiple companies drones delivering to the chosen location;

FIG. 15 illustrates a package pick-up and delivery by autonomous drones in a residential neighborhood using the PLP system pods;

FIG. 16 illustrates multiple drone deliveries and pick-ups in an urban setting with the PLP pods having varied altitude protocols; and

FIG. 17 is a PLP flow chart describing one possible method for autonomous drone package delivery. Reversal of this flow chart with variations could be used for a package pick-up.

### DETAILED DESCRIPTION

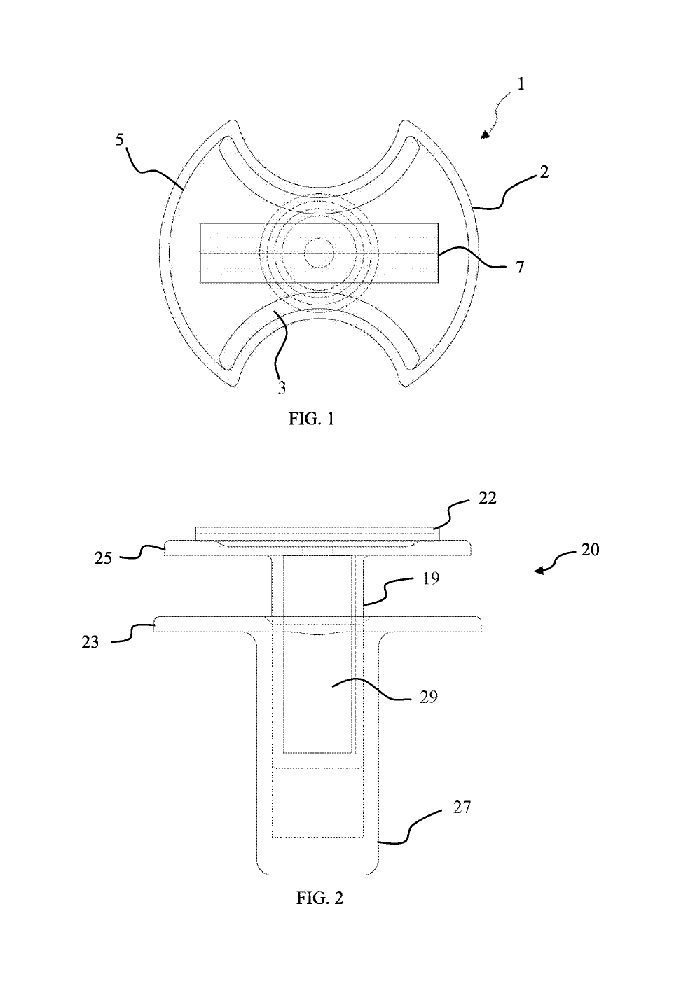

FIG. 1 illustrates a navigation pod 1 (also referred to as a “Multi-operational Orientation Monitoring System” abbreviated as “MOMS”). An embodiment of a navigation pod 1 is designed to be placed or embedded at least partially within a road or roadway, such as a pavement road. An upper portion 5 is placed into a lower portion 2, with a surface portion 7 located on the top of the upper portion 5. The surface portion 7 may contain a road reflector, solar panel, and/or antenna. In an embodiment, the lower portion 2 includes a receptacle that may be embedded into a surface, such as a road surface, and provides a cavity for the upper portion 5 to seat and connect into. The upper portion 5 may be removably or integrally attached to the lower portion 2. Further, the upper portion 5 may contain wireless or wired communication equipment in a lower chamber 3, the lower chamber 3 being sealed from external elements and housing a central processing unit, memory storage bank, wireless communication equipment, and optionally a power source. In alternative embodiments, the upper portion 5 may be integrated with lower portion 2 in a single navigation pod apparatus so that upper portion 5 is not removable from lower portion 2.

The navigation pod can be constructed of composite materials, hybrid metals, steel, or any other suitable material. In an embodiment, the surface portion 7 of the navigation pod 1 extends partially above a flat surface of a roadway. In one embodiment, the surface portion 7 extends about 0.25 inches above the flat surface of the roadway. This allows the navigation pod 1 to be a two-way roadway reflector for all roadway vehicles. The reflectors can be of any color, but are preferably a standard roadway reflector color (red, white or amber), and utilize standard spacing for reflectors. Each navigation pod is weather-proofed and beveled for water drainage. Each navigation pod is also shielded to prevent unwanted electronic interference, gamma ray bursts or other radiation interference, and hacking.

FIG. 2 illustrates a side view of an embodiment of a navigation pod 20. The navigation pod 20 includes a surface portion 22, an upper portion 25 having a lower chamber portion 19, a lower portion 23 having a receptacle 27 defining a cavity, and an electronic assembly 29. Each navigation pod 20 will be programmed with a unique geo-location position, either prior to being implanted in the roadway or after the navigation pod 20 is installed. The electronic assembly 29 contains wireless communication means including any combination of, but not limited to: a wireless transmitter, wireless receiver, wireless transceiver, WiFi adapter, bluetooth transceiver, RFID transceiver, or any other wireless data transmitter, receiver, or transceiver. The electronic assembly 29 and the surface portion 22 may also generally include sensors, such as by way of non-limiting example, temperature sensors, vibration sensors, accelerometers, or moisture sensors. Each navigation pod 20 may link, in real-time, its unique geo-location with other installed navigation pods 20 in a wireless sensor network. A wireless sensor network may include a plurality of primary navigation pods, as described further below, and at least one secondary navigation pod as described elsewhere herein. The primary navigation pods can broadcast their respective latitude, longitude, and altitude coordinates. The primary navigation pods can transmit their respective coordinates to a cloud network without requiring line-of-sight with the sky. This feature is beneficial in situations such as underground locations, tunnels, or among tall buildings or hills.

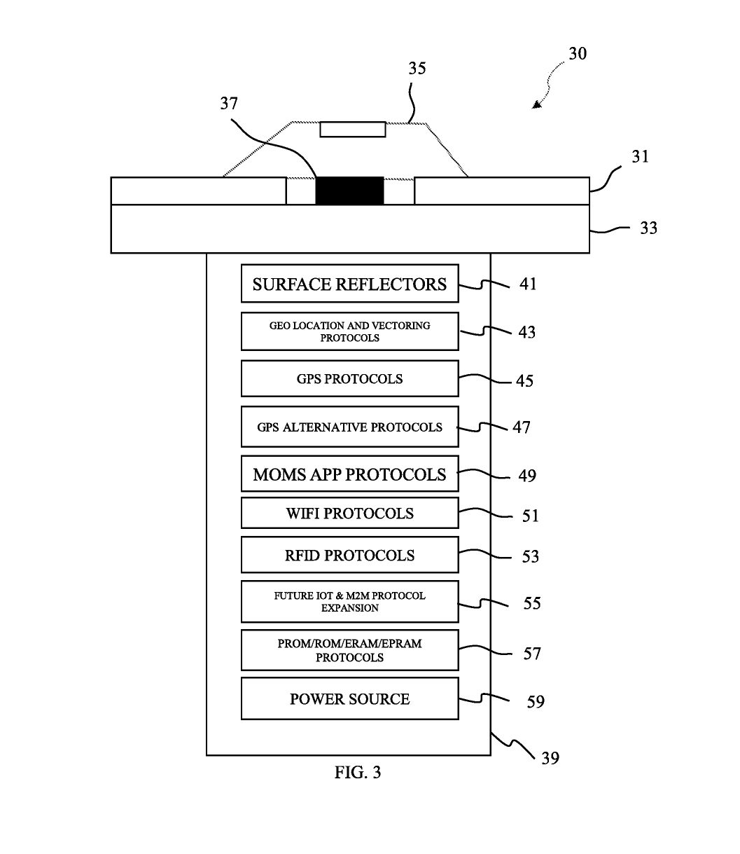

FIG. 3 illustrates a side view of an embodiment of a primary navigation pod 30 containing a block diagram outlining features and protocols of the present embodiment. The primary navigation pod 30 includes a surface portion 35, a conduit opening 37, a lower portion 33, a lower chamber 39, a surface reflector 41, and a number of internal components and protocols. The primary navigation pod 30 contains a power source 59, which may by way of non-limiting example be a solar cell located on the surface portion 35, a wired power connection, a long-term battery, or any other suitable source of power. The internal components may be shielded from weather and electronic interference. The navigation pod may include a memory that may include geo location information and vectoring protocols 43 used to identify the location of vehicles. Further, the navigation pod 30 can include a GPS protocol and transceiver 45, a backup GPS system 47, specific pod applications 49 for the day-to-day running of the pod, WiFi transceivers 51, RFID receivers and transmitters 53, an expansion slot 55, and PROM/ROM/ERAM/EPRAM protocols 57. The primary navigation pod 30 is thus capable of communicating in real-time with any type of vehicle or machine including, but not limited to cars, trucks, bikes, buses, trains, drones, or aircrafts. The primary navigation pod 30 is further capable of communicating in an “Internet of Things” or a “Machine to Machine” network.

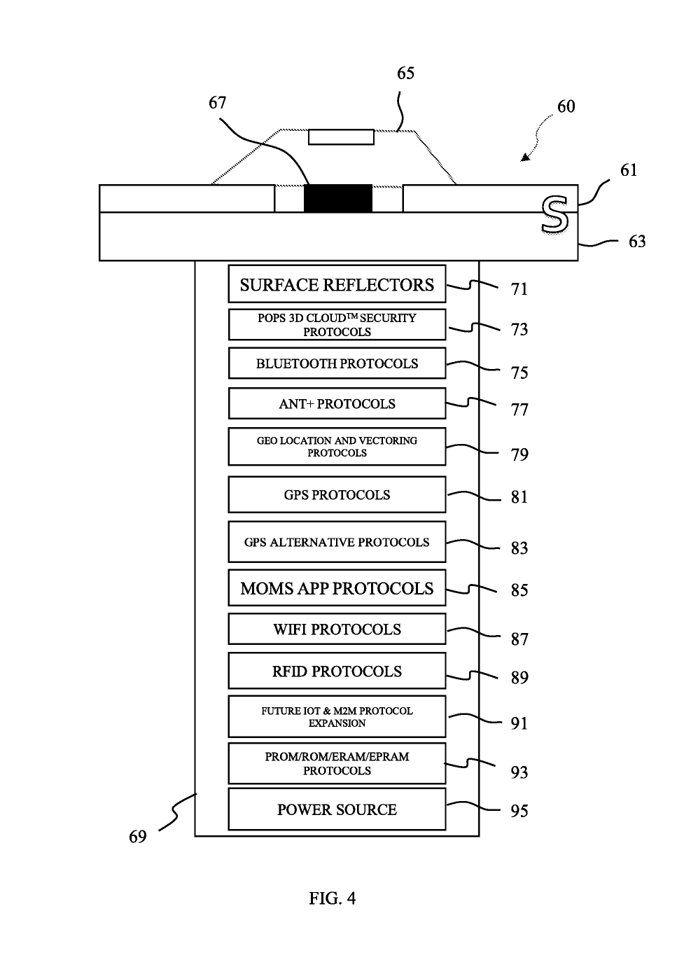

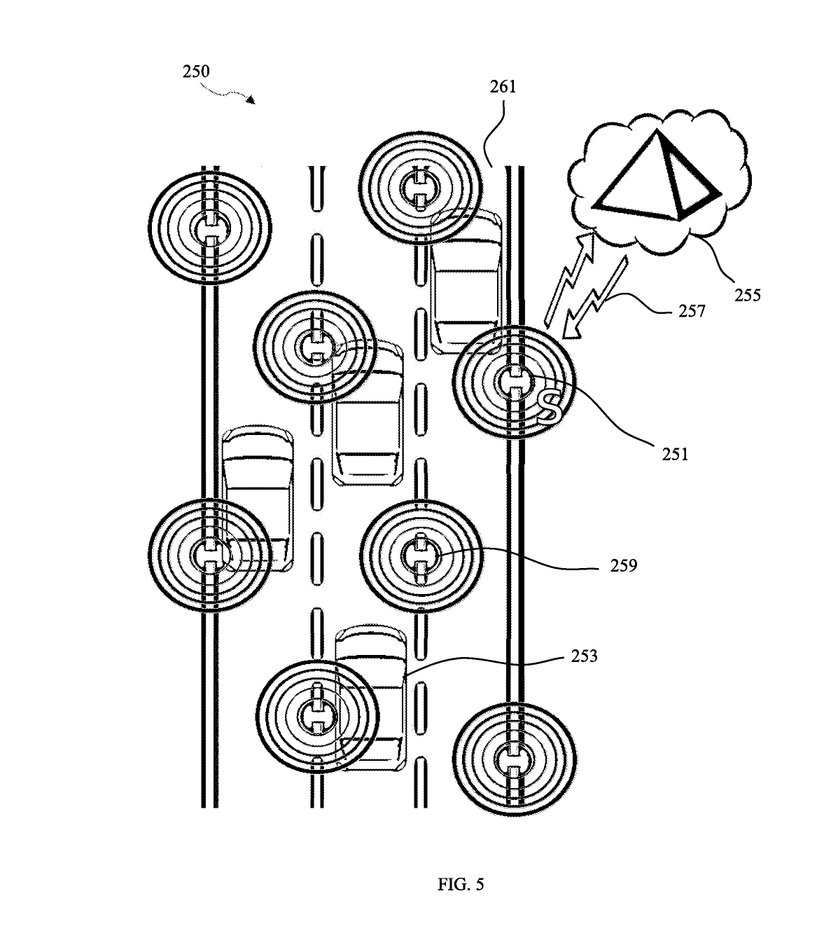

FIG. 4 illustrates a side view of an embodiment of a secondary navigation pod 60 (also referred to as “Super MOMS”) displaying internal components and internal component protocols. The secondary communication pod 60 comprises a surface portion 65, an upper portion 61, a lower portion 63, a surface reflector 71, a power source 95, a lower chamber 69, and a multi-function port 67 which can be used for technology fusion such as a USB interface, or as a power source such as an AC adaptor.

The lower chamber 69 contains internal components that may be shielded from weather and electronic interference. The bottom chamber 69 houses an electronics suite including security protocols 75, ANT/ANT+protocols and transceivers 77, Bluetooth protocols 75, Geo location and vectoring protocols 79, GPS protocols 81 and backup GPS system 83, an application 85 to run the navigation pod 60, a Wi-Fi transceiver or receiver 87, RFID protocols and transceiver 89, an expansion slot 91, and PROM/ROM/ERAM/EPRAM protocols 93. The secondary navigation pod 60 can comprise any component and can function any way as previously described of the primary navigation pod 30 (FIG. 3). In one embodiment, the secondary navigation pod 60 is further capable of connecting either wirelessly or by wire with two-way communication in real-time to a cloud network or the internet.

The secondary navigation pods 60 and the primary navigation pods 30 are capable of communicating with each other, either by wire or wirelessly. In an embodiment, both the primary and secondary navigation pods are in direct communication with any other navigation pods within certain proximity. By relaying information through additional navigation pods, a pod in one geographical location can communicate and send information to another pod a far enough distance away where direct communication would have been impossible. In additional embodiments, the secondary navigation pods may contain the necessary electronics to communicate to the internet while the primary navigation pods may not. In an exemplary embodiment, the number of primary navigation pods is greater than the number of secondary navigation pods. In another embodiment, the number of primary navigation pods is less than the number of secondary navigation pods. In some embodiments, when installed in the road, primary navigation pods 30 and secondary navigation pods 60 may be visually or physically indistinguishable.

FIG. 5 illustrates a multi-lane highway with a sensor network 250 formed by a plurality of primary navigation pods 259 and at least one secondary navigation pod 251 communicating in real-time with vehicles 253. The vehicles 253 can triangulate their position on the roadway 261 using, in one embodiment, the signal strength and position information taken from the sensor network 250. The secondary navigation pod 251 is in wireless communication 257 with the internet 255, and can send the vehicle 253 alert or traffic information either directly or through the primary navigation pods 259. Ordinary trigger alerts and response protocols are embedded in the primary navigation pods 259 and the secondary navigation pods 251 and dispersed to vehicles 253 in real-time. Certain critical alerts can be announced to vehicles 253 and also sent to the internet 255. The secondary navigation pod 251 can relay event information to and from the internet 255 in real-time.

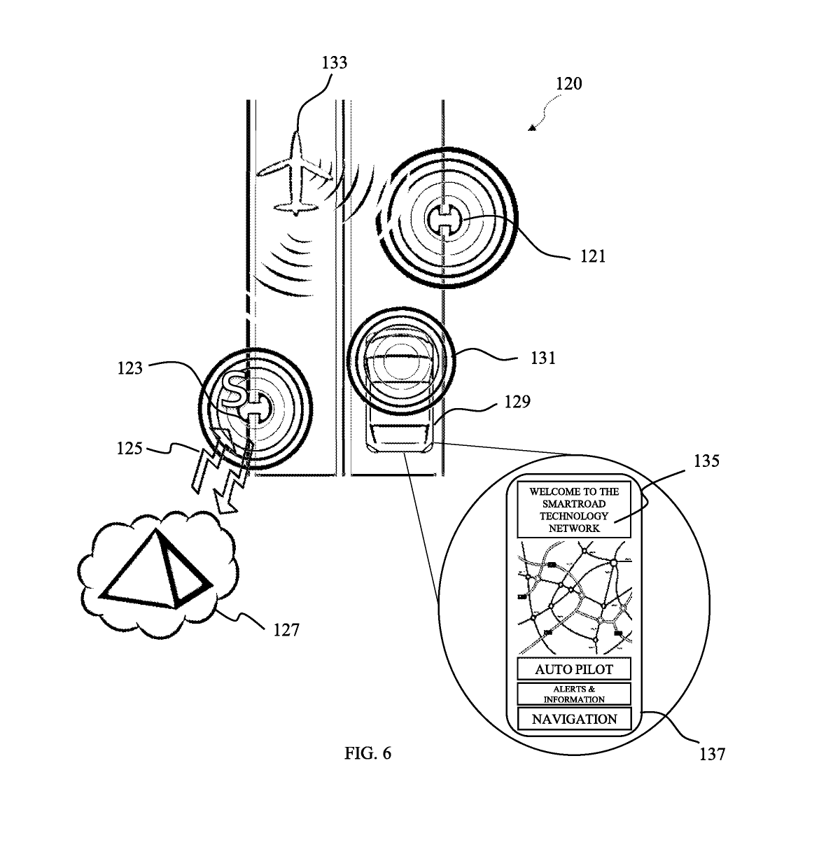

FIG. 6 illustrates a user interface to a navigational system 120 through the use of an application. The application 135 can be installed on a mobile device 137 such as a smartphone, tablet, or laptop computer, or it can be installed as part of a vehicle's software or user interface. The application 135 is capable of communicating information in real-time to any of the primary navigation pods 121, the secondary navigation pods 123, additional vehicle user interface software, vehicle control software, an outside network, and the internet 127. The navigation pods are embedded in a roadway 131 and can communicate in some embodiments to an aerial vehicle 133 and the internet 127 via wireless communication 125.

In an embodiment, the application 135 communicates information through a secondary navigation pod 123 to the cloud network or internet 127. The internet 127 sends information and responses back to a secondary navigation pod 123 and then on to at least one of the primary navigation pods, an outside network, a vehicle's software, or the application 135 software. The application 135 can also work with any cellular network for a greater roadway experience. The application 135 can be programmed and developed differently for each phone manufacturer's desired experiences.

The application 135 has various functions. For example, the application 135 can allow a user to control settings or commands related to the navigational system including toggling autonomous driving modes on and off for autonomous vehicles, view maps, view navigation, view notifications or alerts provided by the internet 127, and alert a user of road, traffic, or emergency conditions based on information received via the internet 127.

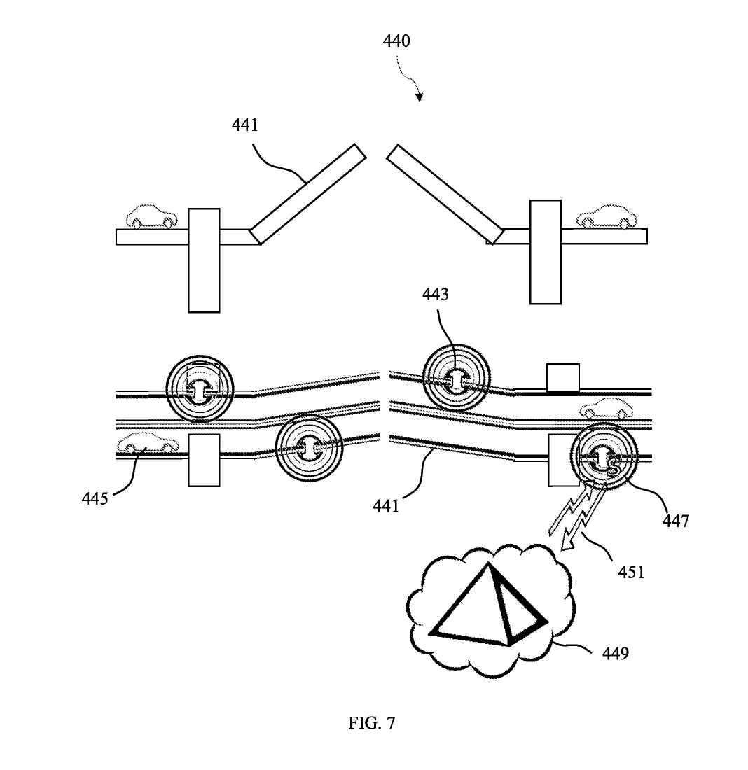

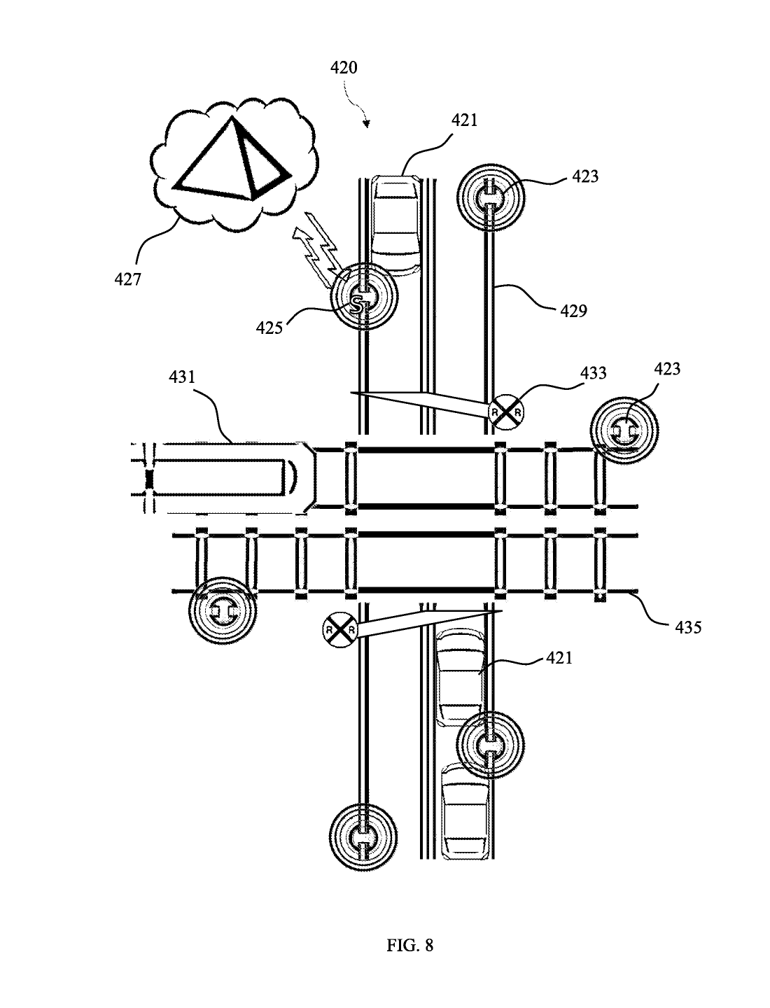

FIG. 7 illustrates the use of an embodiment of the invention with a drawbridge to provide a warning system 440. The warning system 440 includes a draw bridge 441, a plurality of primary navigation pods 443, a roadway vehicle 445, and a plurality of secondary navigation pods 447 in wireless or wired communication 451 with the internet 449. The primary navigation pods 443 can detect when the bridge 441 is in the “up” position and relay that information to the secondary navigation pods 447 and the roadway vehicle 445. Further, the primary navigation pods 443 can assist the drawbridge during opening and closing of the bridge by detecting the movement speed and vibrations within the bridge 441.

FIG. 8 illustrates an embodiment of a navigation system 420 at a train intersection with a roadway. A plurality of primary navigation pods 423 are embedded in the roadway 429 and near the train tracks 435. A plurality of secondary navigation pods 425 and the plurality of primary navigation pods 423 form a network which can detect a train 431 approaching the intersection. Upon detecting a train 431 approaching, in some embodiments the system can trigger the gates 433 to drop and alert the roadway vehicles 421 of the approaching train via wireless communication through either the primary navigation pod 423 or secondary navigation pod 425.

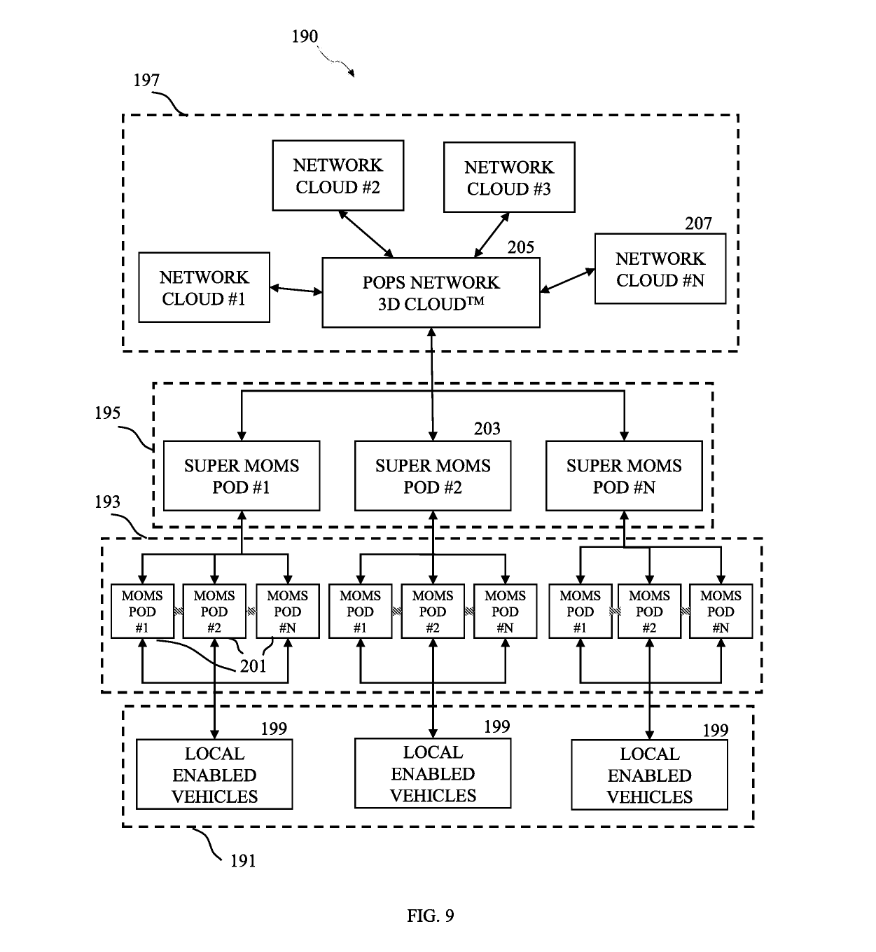

FIG. 9 displays a hierarchy of the communication relationship between vehicles 199, primary navigation pods 201, secondary navigation pods 203, and the cloud network 205. The cloud network 205 securely interacts within and between other outside private, hybrid, and public clouds 207. This interaction allows for shared data with other cloud technologies, but allows individual propriety and security to remain intact.

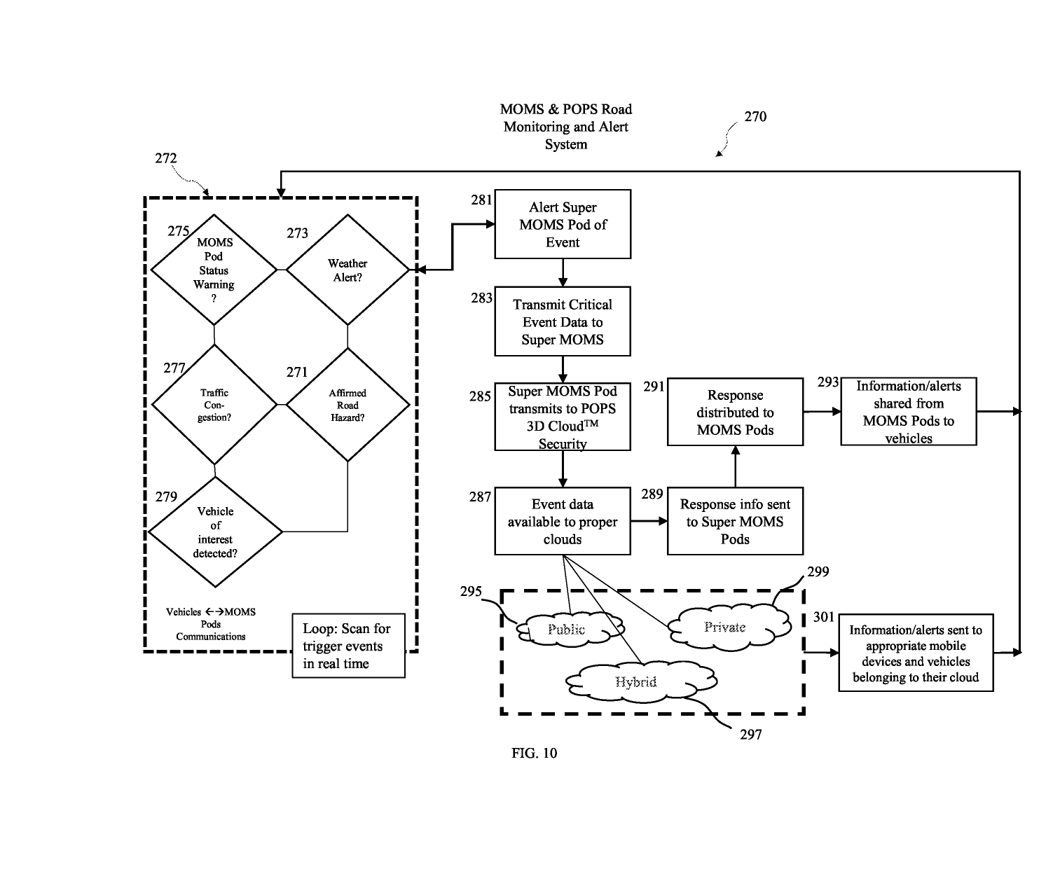

FIG. 10 depicts a flow chart of an embodiment of the information distributing process of the alert network 270. A trigger event 272 is scanned for in a continuous loop, a trigger event including but not limited to an equipment status warning 275, a weather alert 273, a road hazard 271, traffic congestion 277, or a vehicle of interest is detected 279. Once a trigger event 272 occurs, a secondary navigation beacon 281 is alerted and receives information regarding the event 283 from primary navigation beacons. The secondary navigation beacon transmits the information to the Internet 285 in a manner ensuring that a variety of public clouds 295, private clouds 299, and hybrid clouds 297 have access to that information. Those clouds may then update appropriate parties, such as mobile devices located inside vehicles 301. The secondary navigation beacon then receives additional information regarding a response 289, which is then distributed through the network 291 and shared with local vehicles 293.

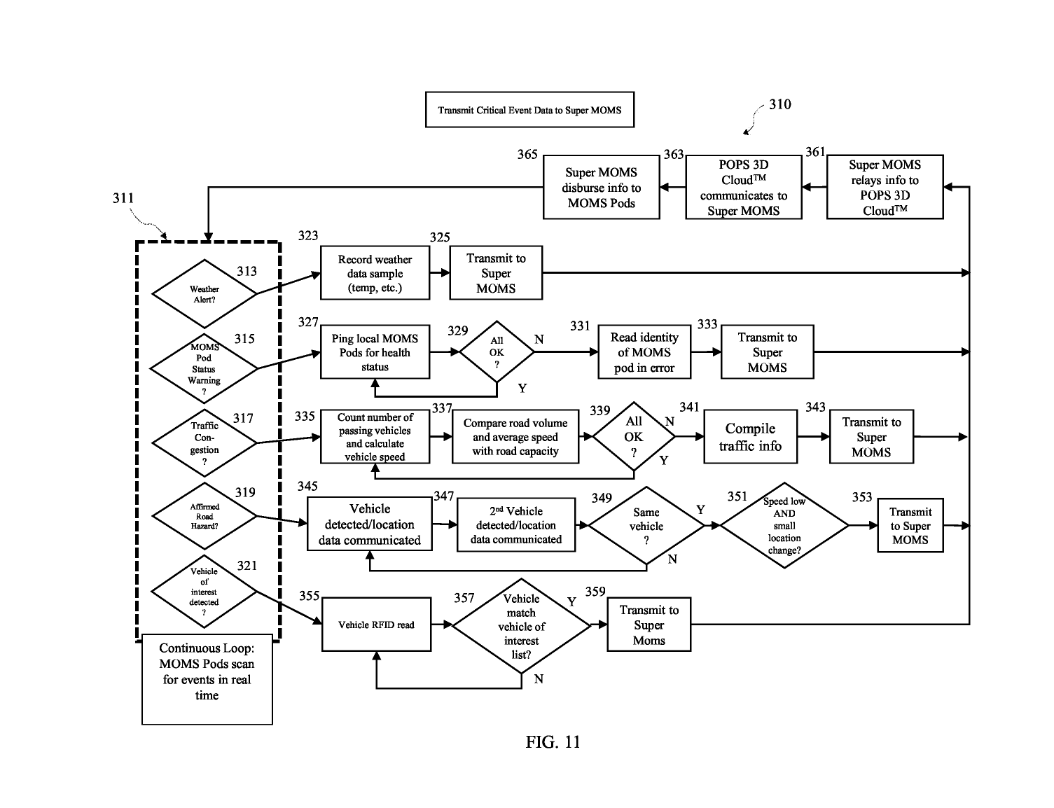

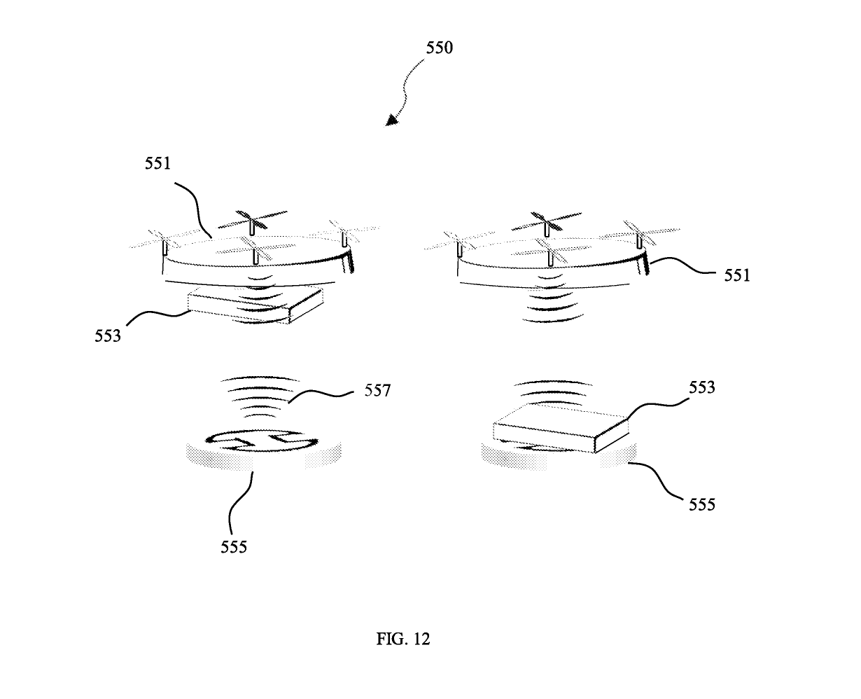

FIG. 11 is a flow chart of how event information is transmitted to a secondary navigation pod 310, which can be in some embodiments an expansion of element 283 in FIG. 10. When an event 311 is triggered, the method of response will vary depending on the nature of the alert. A weather alert 313 will cause primary navigation beacons to record weather data 323, such by way of non-limiting examples in some embodiments temperature or humidity, and then transmit that information to the secondary navigation pods 325. An equipment status warning 315 will cause an inquiry by nearby secondary navigation pods 327 until a health status is determiner 329. Upon determining an equipment failure, the location and identity of the broken equipment is determined 331 and that information is transmitted to a secondary navigation beacon 333. A traffic congestion warning 317 will cause the primary navigation pods to sense the number of passing vehicles and their speed 335. A primary navigation pod will compare the volume and speed of the vehicles 337 to a baseline value, and if the there is a deviation above a certain threshold value 339 the primary navigation pods will compile traffic info 341 and transmit it to the secondary navigation beacons 343. If there is a road hazard 319, such as a broken vehicle or other obstruction, the primary navigation beacons detect the vehicle 345 and wait a period of time, later detecting another vehicle during normal operation 347. If the vehicle detected in 345 is the same vehicle in step 347, then 349 the primary navigation pods look to see if the vehicle is moving at a low speed and displacement 351 and transmit that information to secondary navigation pods 353. A vehicle of interest is detected 321 by scanning, for example, an RFID chip 355 and comparing the information against a list of vehicles of interest 357. If there is a match, that information is transmitted to a secondary navigation pod 359.

Regardless of which alert occurred or was detected, the information transmitted to a secondary navigation pod is relayed to the internet 361 for analysis by a computing cloud or server. After analysis of the particular alert, the computing cloud communicates reactionary or status information to the secondary navigation beacon 363, which is then distributed to the primary navigation beacons 365 and then to any roadway vehicles.

FIG. 12 generally illustrates a landing pad for a drone delivered package 550. The landing pad 555 is capable of communicating via a wired connection to a network or wirelessly 557 with a drone 551. In some embodiments, the drone 551 carries a package 553 and may deliver the package on or in the vicinity of the landing pad 555.

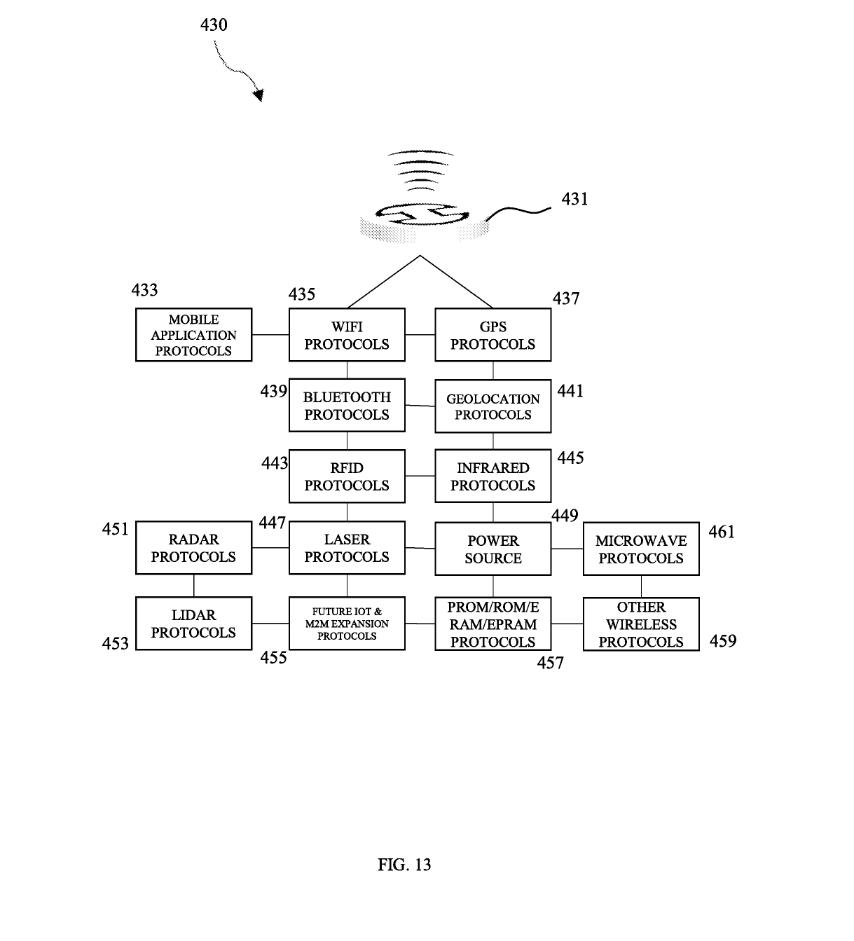

FIG. 13 generally illustrates the wireless protocols and internal components of a landing pad 430. The landing pad 431 may contain Wi-Fi protocols 435, GPS protocols and transceivers 437, Bluetooth protocols and transceivers 439, geolocation protocols generally 441, RFID protocols 443, Infrared protocols 445, radar protocols 451, laser protocols 447, a power source 449, microwave protocols 461, lidar protocols 453, an expansion slot 455 which can accompany additional upgrades, PROM/ROM/ERAM/EPRAM protocols 457, and any other suitable wireless signal for communicating with a drone. The landing pad 431 may also be accessed by an application 433. Each personal landing pad can be configured to a chosen size, shape, and can be chosen to include the technology protocols desired by the consumer.

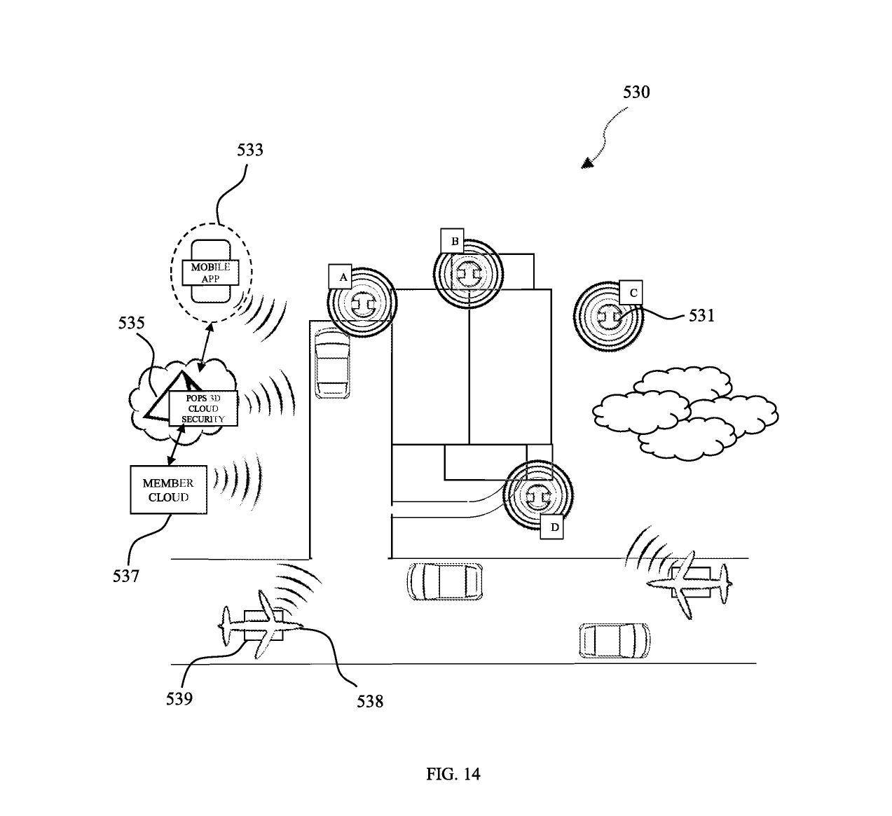

FIG. 14 generally illustrates the use 530 of a personal landing pad. A landing pad 531 capable of communicating wirelessly with a drone 538 may be placed anywhere on a property of a user, preferably placed in an adequate location to safely receive a package. This placement can be permanent or temporary. By way of non-limiting example and for illustrative purposes only, it may be located in position A, B, C, or D. There may also be a plurality of landing pads 531 or just a single pad. The drone 538 carries a package 539 intended to be delivered to the user. The drone 538 can use the personal landing pad 531 location in order to rapidly identify the proper placement and location for a delivery and drop-off of the package 539. The landing pad 531 may in some embodiments be in wireless communication with a cloud or the internet 537 through a security protocol 535 and a mobile application 533.

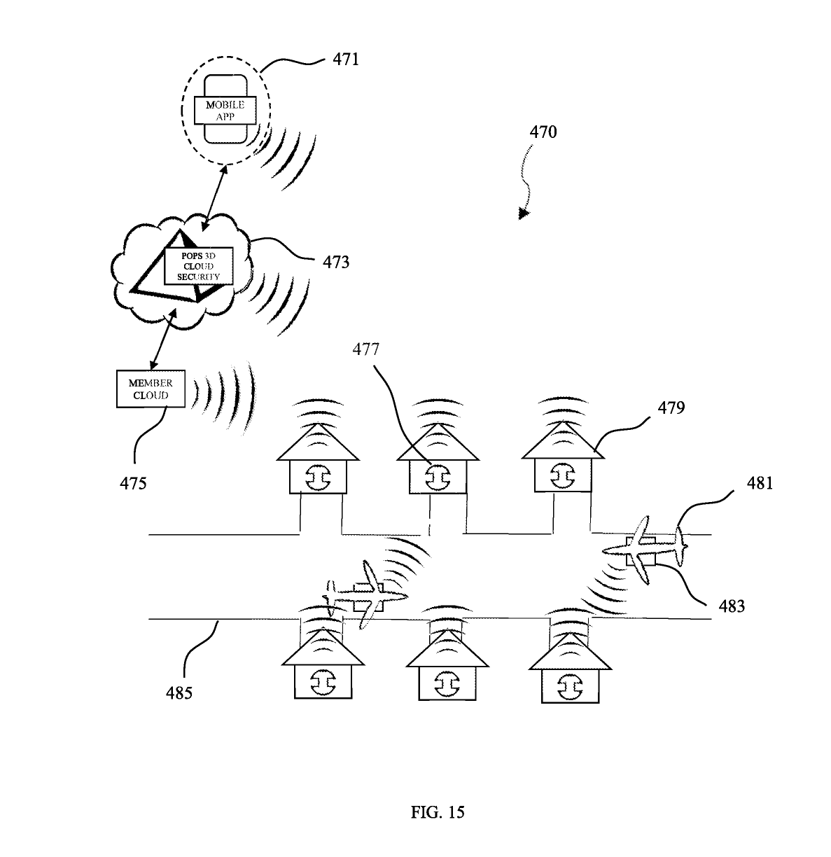

FIG. 15 generally illustrates a neighborhood level view 470 of a plurality of personal landing pads. The landing pads 477 may be located at a number of houses and residences 479, each landing pad 477 emitting a wireless signal. A drone 481 carrying a package for delivery 483 can use the wireless signals from the landing pads 477 in order to quickly identify and triangulate its location. This information may also be sent through the internet or a cloud 475 using security protocols 473 and a mobile application 471.

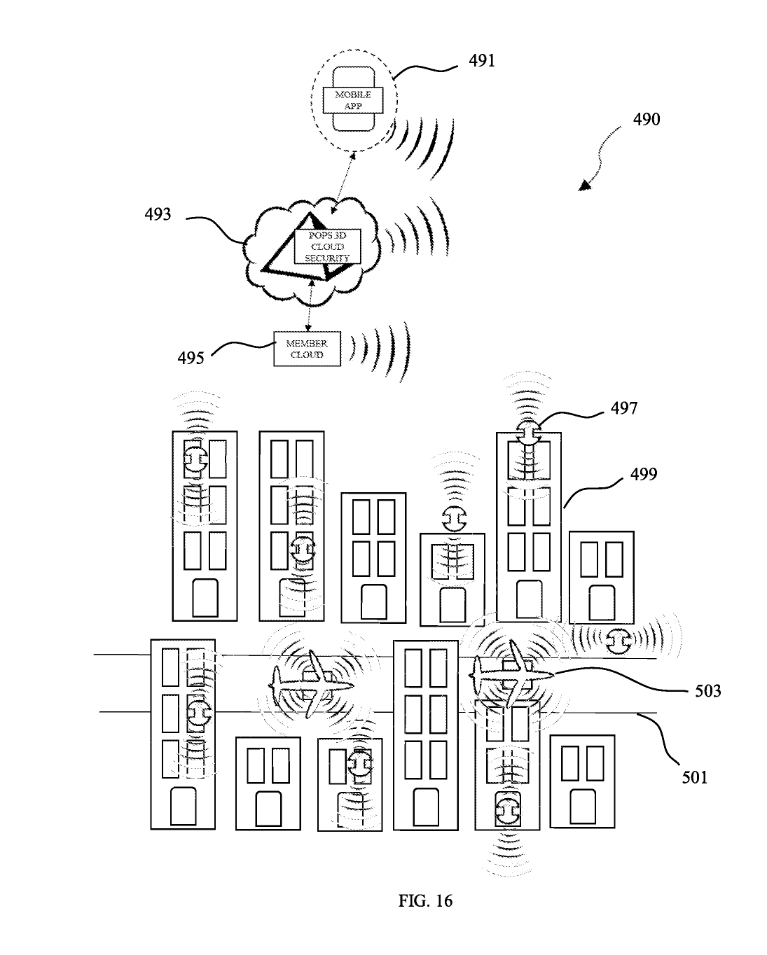

FIG. 16 generally illustrates a city level view 490 of a plurality of landing pads. The landing pads 497 may be placed at varying heights in a multi-story building 499. A drone 503 carrying a package for delivery can triangulate its location and altitude using not only the geographical location of the landing pads 497 but the vertical placement of the pads as well. The drone 503 and landing pads 497 can wirelessly communicate with each other directly and can also communicate with or through a computational cloud 495 with a security protocol 493 and a mobile application 491.

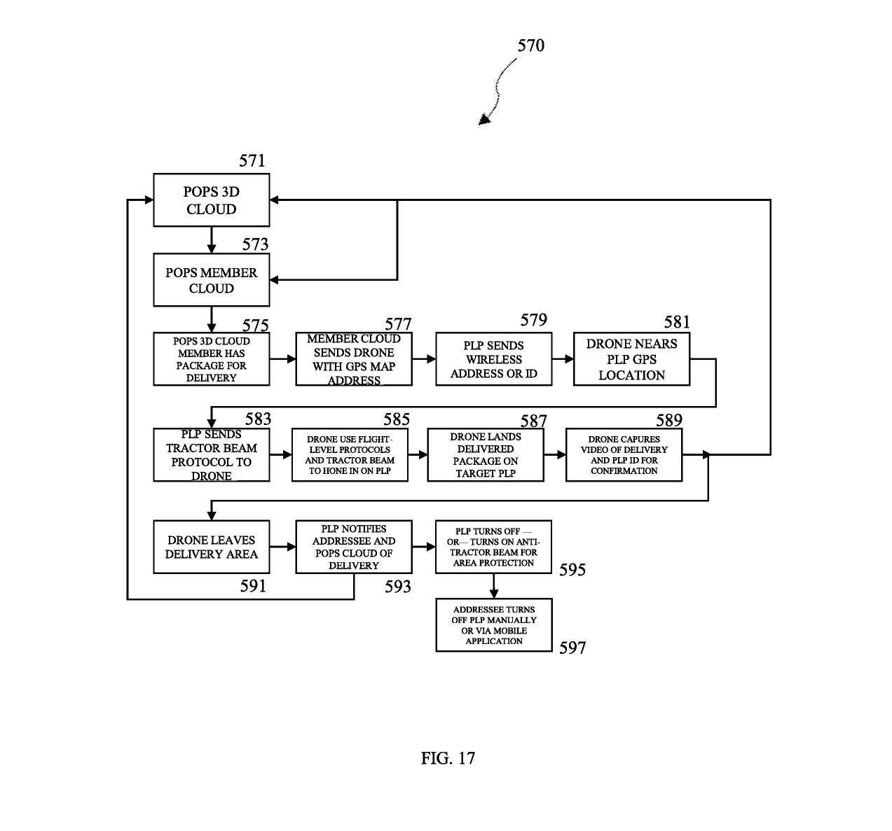

FIG. 17 is a flow diagram of a typical delivery scenario using a drone 570. A computation cloud 571 segments its resources and assigns a portion of memory to a member 573. That member sends the cloud a signal request for a delivery of a package 575. The cloud then send a drone with a delivery location and package out to deliver the package 577, while a personal landing pad begins to send out an identification signal 579. The personal landing pad can also wirelessly beacon or broadcast its specific GPS identification which can include its latitude, longitude, and altitude. The personal landing pads and the drones can utilize the navigational system described previously for accuracy and security, allowing the drones to travel along a specific, recognized pathway to the location of the personal landing pad. The drone then approaches a general known location of the personal landing pad 581. Once the drone is in proximity of the landing pad, the landing pad sends the drone a focused signal 583 designed to guide the drone 585 onto the landing pad, where the drone executes a landing 587. The drone then captures information necessary to identify that a delivery had occurred 589 and leaves the area 591. The landing pad notifies the personal landing pad owner of the delivery 593. The landing pad can then turn on, turn off, or signal that no additional deliveries are desired 595. Finally, a user can manually shut down the personal landing pad 597. The landing pad can be activated/deactivated by way of a switch and/or a cell phone application that can issue the command.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A navigation pod comprising:
a surface portion and a chamber portion, the chamber portion comprising at least one short-range wireless transceiver and a memory, and the surface portion adapted to seal the chamber portion;
wherein the memory comprises geo-location data of the navigation pod; and
wherein the at least one short-range wireless transceiver is adapted to communicate with at least one other navigation pod and is capable of transmitting the geo-location data to an external receiver capable of receiving the geo-location data.

2. The navigation pod of claim 1, further comprising an upper portion and a lower portion, the upper portion comprising the surface portion and the chamber portion, and the lower portion comprising a receptacle, the receptacle adapted to be embedded in a surface, and the receptacle defining a cavity capable of receiving and connecting to the upper portion.

3. The navigation pod of claim 1, wherein the navigation pod is a primary navigation pod and the at least one other navigation pod is a secondary navigation pod configured to communicate with an external server.

4. The navigation pod of claim 3, wherein the at least one short-range wireless transceiver is further adapted to transmit the geo-location data to a receiver of an other navigation pod and to receive additional geo-location data from the other navigation pod.

5. The navigation pod of claim 1, wherein the navigation pod is a secondary navigation pod and the at least one other navigation pod is a primary navigation pod, the secondary navigation pod further comprising a long-range wireless transceiver adapted to communicate with an external server.

6. The navigation pod of claim 5, wherein the secondary navigation pod is further configured to receive data from and send information to the internet.

7. The navigation pod of claim 5, wherein the secondary navigation pod is further configured to receive data from and send information to a cloud computing network.

8. The navigation pod of claim 5, wherein the secondary navigation pod is one secondary navigation pod of a plurality of secondary navigation pods, the one secondary navigation pod being configured to communicate with at least one other secondary navigation pod of the plurality of secondary navigation pods.

9. The navigation pod of claim 4, wherein the primary navigation pod is one primary navigation pod of a plurality of primary navigation pods, the secondary navigation pod being configured to communicate with the plurality of primary navigation pods.

10. A navigational system comprising:
a plurality of primary navigation pods and at least one secondary navigation pod, the plurality of primary navigation pods and at least one secondary navigation pod comprising at least one short-range wireless transceiver and a memory comprising geo-location data;
wherein one primary navigation pod of the plurality of navigation pods is adapted to communicate the geolocation data with at least one other primary navigation pod and the at least one secondary navigation pod via the at least one short-range wireless transceiver, and is capable of transmitting the geo-location data to an external receiver capable of receiving the geo-location data; and
wherein the at least one secondary navigation pod is adapted to communicate with the plurality of primary navigation pods and further comprises at least one long-range wireless transceiver configured to communicate with an external server.

11. The navigational system of claim 10, wherein the external receiver is a receiver coupled to a roadway vehicle.

12. The navigational system of claim 10, wherein the receiver is a receiver coupled to an aerial vehicle.

13. The navigational system of claim 10, where the memory further comprises a position dataset corresponding to a position of each of the plurality of primary navigation pods or the at least one secondary navigation pod.

14. The navigational system of claim 13, where either one primary navigation pod of the plurality of primary navigation pods or the at least one secondary navigation pod is capable of sending the position data set to the external receiver.

15. The navigational system of claim 10, where the plurality of primary navigation pods and the at least one secondary navigation pod are embedded within a roadway at selected increments.

16. The navigational system of claim 15, where the selected increments are located in a center line of the roadway.

17. The navigational system of claim 10, where a ratio between the plurality of primary navigation pods and the plurality of secondary navigation pods is greater than 1.

18. The navigational system of claim 1 further comprising a tertiary navigational sensor in communication with a railway system, the tertiary navigational sensor communicating to the plurality of primary navigation pods and the at least one secondary navigation pod a status of the railway system.

19. A landing pad comprising:
A surface portion capable of accepting a package delivered from a drone;
a memory comprising geo-location data of the landing pad;
a first transceiver capable of communicating with an external communication network;
a second transceiver capable of communicating with a receiver coupled to a drone apparatus, the second transceiver adapted to transmit the geo-location data of the landing pad; and
wherein the landing pad is capable of communicating to at least a second landing pad.

20. (canceled)
